(19) United States
(12) Patent Application Publication
(10) Pub. No.: US 2009/0050415 A1
(43) Pub. Date: Feb. 26, 2009

(54) Goods presentation arrangement

(75) Inventors: Udo Preussler, Leinfelden-Echterdingen (DE); Stefan Schwarz, Altdorf (DE); Michael Noack, Contwig (DE)

Correspondence Address: HOFFMANN & BARON, LLP, 6900 JERICHO TURNPIKE, SYOSSET, NY, 11791, US

(73) Assignee: Festo AG & Co., KG and MTD Products AG

(21) Appl. No.: 12/228,614

(22) Filed: Aug. 14, 2008

(30) Foreign Application Priority Data
Aug. 21, 2007 (DE) 20 2007 011 680.2

(51) Int. Cl. B66F 1/00

(52) U.S. Cl. 187/275; 187/276

(57) ABSTRACT

In a goods presentation arrangement with a base part (15) that can be placed on the ground by means of legs (14) and features a lifting device (16) with a lifting bottom (33) that can be raised with the aid of lifting means and carries the goods and also features a control device (40) that is assigned to the lifting device (16) and serves for controlling the lifting means, the control device (40) forms part of an exchangeable plug-in module (31) that can be inserted into a receptacle shaft (30) on the base part (15) and is arranged above the legs (14).

### BACKGROUND OF THE INVENTION

The invention pertains to a goods presentation arrangement with a base part that can be placed on the ground by means of legs and features a lifting device with a lifting bottom that can be raised with the aid of lifting means and carries the goods, as well as a control device that is assigned to the lifting device and serves for controlling the lifting means.

A goods presentation arrangement of this type is known from DE 10 2004 048 428 A1, wherein this arrangement is provided with a lifting device that features a cushion that can be expanded by means of internal fluid pressure such that a container bottom carrying the goods can be raised. This goods presentation arrangement is referred to as a container and consists of a pallet with legs, side walls that can be attached to the pallet and the lifting device. Furthermore, a control device is provided for controlling the lifting device, wherein said control device is accommodated in one of the pallet legs and comprises a pump, a valve and a switching device that are combined into one unit.

The accommodation of the control device in the pallet leg is costly. In addition, if one of the components of the control device is damaged or malfunctions, the pallet and therefore the entire goods presentation arrangement is no longer usable.

### SUMMARY OF THE INVENTION

Consequently, the invention is based on the objective of developing a goods presentation arrangement of the initially mentioned type that can be handled more flexibly and used more universally than conventional goods presentation arrangements known from the state of the art.

This objective is attained with a goods presentation arrangement with the characteristics of independent Claim 1. Additional developments of the invention are disclosed in the dependent claims.

The inventive goods presentation arrangement is characterized in that the control device forms part of an exchangeable plug-in module that can be inserted into a receptacle shaft in the base part and is arranged above the legs.

If one of the components of the control device is damaged or malfunctions, it is therefore merely required to exchange and replace the plug-in module with a fully functional plug-in module. This exchange can be realized quickly and inexpensively if spare plug-in modules are on hand. Consequently, the goods presentation arrangement can be used again after a short time.

It is particularly preferred that the legs form part of a carrier pallet that is realized separately from and carries the base part. This means that the plug-in module is not situated in the carrier pallet, but rather in a separate component, namely the base part. It is not necessary to use special carrier pallets with control devices integrated into one of the pallet legs since conventional standard pallets can be used. This advantageously makes it possible to retrofit standard pallets with a lifting device.

It is furthermore possible to interchange base parts, for example, if the lifting device integrated into the base part is damaged or malfunctions.

It is particularly preferred to provide a fluidic lifting device with lifting means in the form of several fluidic actuators that can be filled by means of a compressed fluid independently of one another. Compressed air is preferably used as the compressed fluid.

It is practical if the fluidic actuators consist of lifting cushions that can be expanded by means of fluid pressure. It is therefore possible to realize a lifting cushion arrangement with several lifting cushions that can be expanded separately from one another.

It is particularly preferred to respectively assign an expansion limiting device to the lifting cushions in order to limit the lifting cushion expansion, namely such that the upper side and the lower side form supporting surfaces that are aligned parallel to one another in the expanded state of the lifting cushion. This makes it possible to prevent the lifting bottom and therefore the goods arranged thereon from assuming an inclined position during the expansion of the lifting cushions.

It is practical if the expansion limiting device is formed by a tension thread arrangement with several tension threads that is integrated into the lifting cushion.

In an additional development of the invention, the plug-in module features a module housing, in which the components of the control device are accommodated. Alternatively, it would also be possible to realize a variation without a housing, for example, in the form of a plug-in strip fitted with the components of the control device.

It is particularly preferred that the control device feature a valve mechanism for controlling the lifting means, a control unit for controlling the valve mechanism, a fluid supply device arranged upstream of the valve mechanism, a power supply unit and an activation device that is coupled to the control unit and serves for activating the lifting device.

It is practical if the control device furthermore features pressure sensors that are arranged, in particular, at the outlet of the valve mechanism and are coupled to the control unit in order to monitor the actual pressure in the fluidic actuators, particularly the lifting cushions. This makes it possible to expand or inflate the lifting cushions up to a maximum fluid pressure that is preferably stored in the control unit. The expansion of the lifting cushion or the lifting cushions can be interrupted once the maximum fluid pressure is reached. It is also possible to specify a minimum fluid pressure to be exerted upon the lifting cushion in the operative state. The respective lifting cushion can be refilled with compressed fluid once the fluid pressure falls short of the minimum fluid pressure.

In an additional development of the invention, the fluid supply device features at least one fluid pressure generator, particularly a compressor that is situated aboard the plug-in module. Alternatively or additionally, it would also be possible to utilize an external fluid pressure generator that can be coupled to the plug-in module via fluid lines.

In an additional development of the invention, the fluid supply device features at least one pressure accumulator that is arranged upstream of the valve mechanism, particularly situated aboard the plug-in module. This makes it possible to also provide compressed fluid in case the fluid pressure generator fails, namely the compressed fluid stored in the pressure accumulator. Naturally, it would also be conceivable for the fluid pressure generator directly to act upon the valve mechanism without an intermediate pressure accumulator.

The power supply unit may feature at least one mains-independent power supply that is situated aboard the plug-in module. This power supply may consist, for example, of at least one accumulator and/or at least one battery. Alternatively or additionally, a connection to the power supply system may also be provided.

In an additional development of the invention, the activation device features an activation switch that is coupled to the control unit such that activation signals can be transmitted. It is particularly preferred that the activation switch be arranged on an external activation module, wherein the signal transmission to the control unit is realized in a wireless fashion, particularly via radio. However, it would also be possible to realize an optical remote transmission. Alternatively, it would also be conceivable to provide an activation switch that is arranged on the goods presentation arrangement, for example, on the base part.

It is particularly preferred that the activation device feature a selector switch that can be switched over between an on-position that allows activation by means of the activation switch and an off-position that blocks activation. This means that the goods presentation arrangement initially needs to be cleared by means of the selector switch before an activation can take place. This is intended to prevent an unintentional activation of the lifting device that is caused, for example, by accidentally pressing the activation switch.

It is preferred that the selector switch be arranged on the plug-in module. The selector switch can be actuated mechanically, e.g., with the hand or the foot and/or via remote transmission, for example, via radio or optically.

In an additional development of the invention, the base part features a frame, in the frame wall of which a slot-like receptacle opening is arranged, wherein said receptacle opening is designed for inserting side walls.

A snap-in device for snapping the side walls into the receptacle opening is preferably assigned to the frame.

One preferred embodiment of the invention is described in greater detail below with reference to the drawings.

### BRIEF DESCRIPTION OF THE DRAWINGS

FIG. 1 shows a perspective representation of one preferred embodiment of the inventive goods presentation arrangement;

FIG. 2 shows the goods presentation arrangement according to FIG. 1 in the form of a longitudinal section along line II-II in FIG. 1;

FIG. 3 shows a perspective representation of a base part of the goods presentation arrangement according to FIG. 1;

FIG. 4 shows an enlarged representation of the base part without lifting device and plug-in module;

FIG. 5 shows a schematic longitudinal section through the base part according to FIG. 3 along line V-V in FIG. 3;

FIG. 6 shows a perspective representation of the plug-in module to be plugged into the base part, and

FIG. 7 shows a schematic representation of the interior design of the plug-in module according to FIG. 6.

### DETAILED DESCRIPTION OF THE PREFERRED EMBODIMENTS

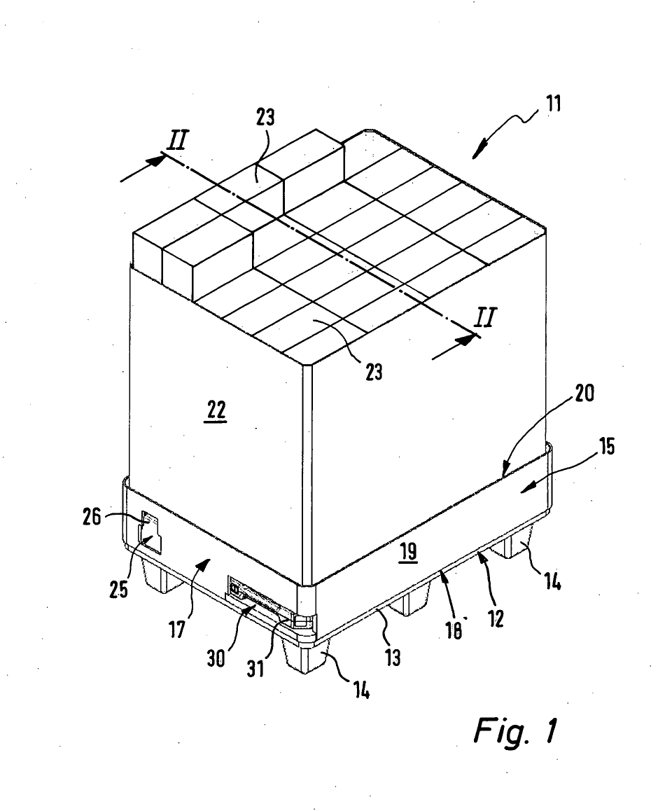

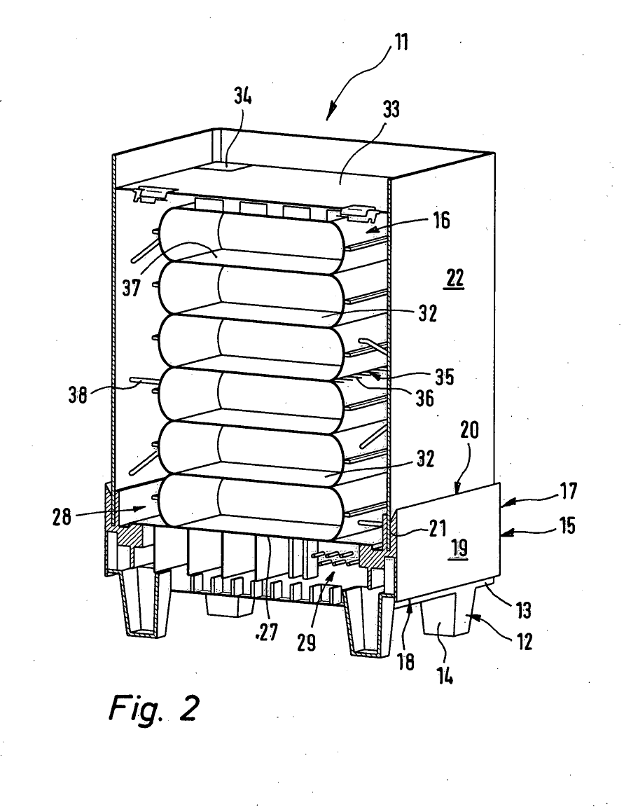

FIGS. 1 and 2 show one preferred embodiment of the inventive goods presentation arrangement 11. The goods presentation arrangement 11 is designed in a modular fashion and features a carrier pallet 12 with a base plate 13 and legs 14 that protrude downward therefrom, as well as a base part 15 that is placed on the base plate 13 of the carrier pallet 12 and contains a lifting device 16.

The carrier pallet 12 used consists of a conventional standard pallet, wherein the lifting fork of a fork lift can be positioned underneath this standard pallet due to its legs 14.

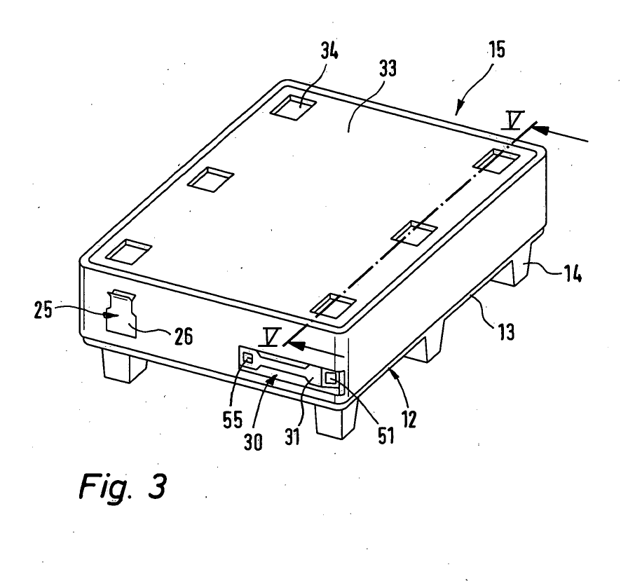

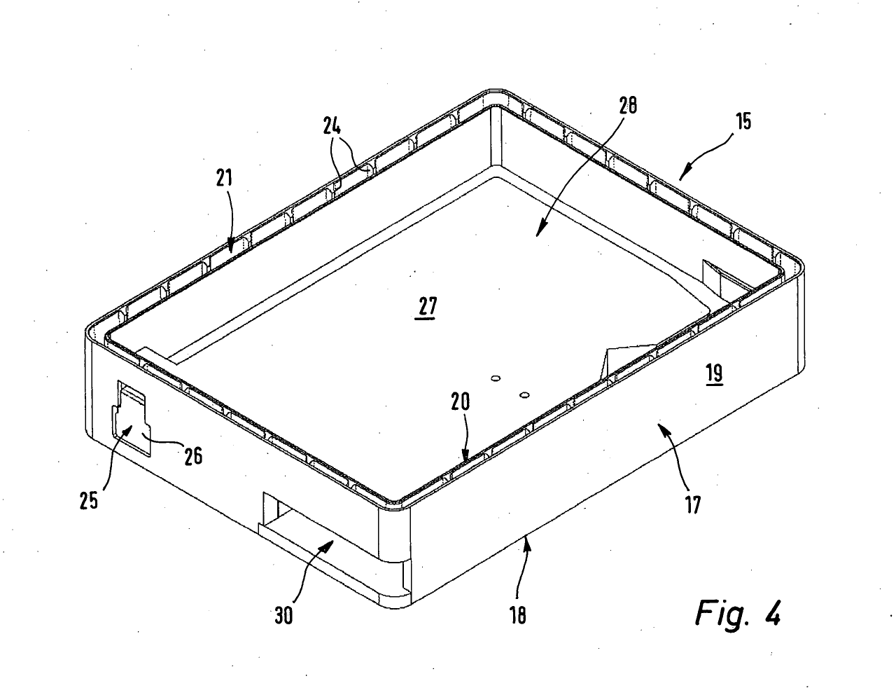

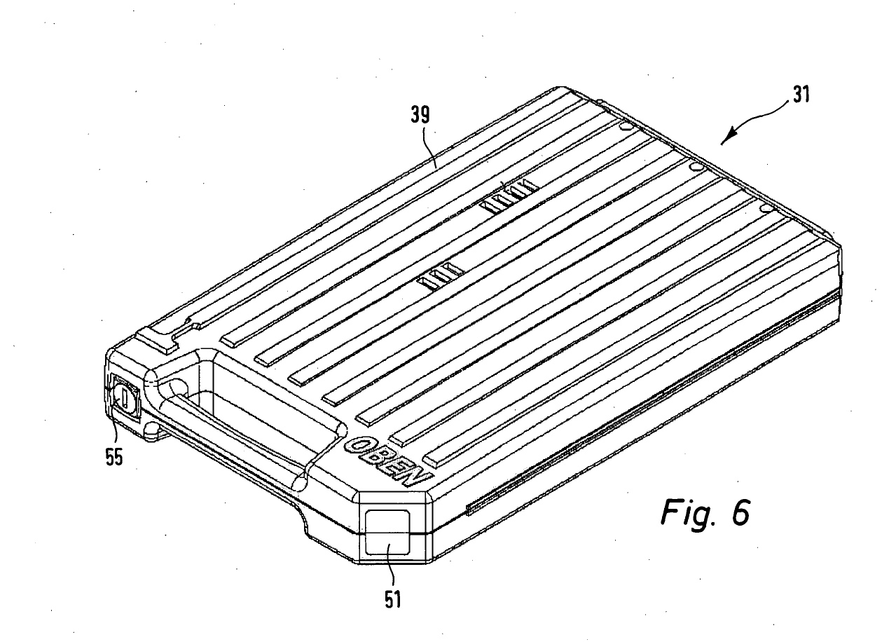

The base part 15 is placed on the carrier pallet 12, particularly in a loose fashion, and consequently can be removed at any time. For example, plastic is one suitable material for the base part. FIGS. 3 to 6, in particular, show that the base part 15 has a rectangular basic shape. A frame 17 has a cross section that is slightly larger than the cross section of the base plate 13 of the carrier pallet 12 such that the lower edge 18 of the frame 17 overlaps the upper frame edge 20 of the base plate 13 during the attachment and the base part 15 is laterally fixed on the carrier pallet 12. The frame 17 furthermore features a frame wall 19 with a slot-like receptacle opening 21 that is open toward the upper frame edge 20 and serves for inserting side walls 22. The side walls 22 preferably consist of cardboard material such that they can be easily disposed of in case the goods 23 in the goods presentation arrangement 11 are completely depleted. FIG. 4, in particular, shows that inwardly protruding web-like projections 24 are respectively situated on the inner sides of the front and rear wall that define the receptacle opening 21, wherein the web-like projections on the front wall lie opposite the web-like projections on the rear wall. The side walls 22 are inserted into the region between the opposing projections 24. In addition, a snap-in device 25 is provided for snapping the side walls 22 into the receptacle opening 21, wherein said snap-in device is also situated on the base part 15 and can be operated from the outer side thereof, for example, by manipulating an actuating handle 26 supported in the frame 17 of the base part 15. This actuation causes the side walls 22 to be snapped into the receptacle opening 21. The base part 15 furthermore features an intermediate bottom 27 that divides said base part into an upper region 28 and a lower region 29, wherein the lifting device 16 is situated in the upper region and a receptacle shaft 30 for a plug-in module 31 described in greater detail below is situated in the lower region.

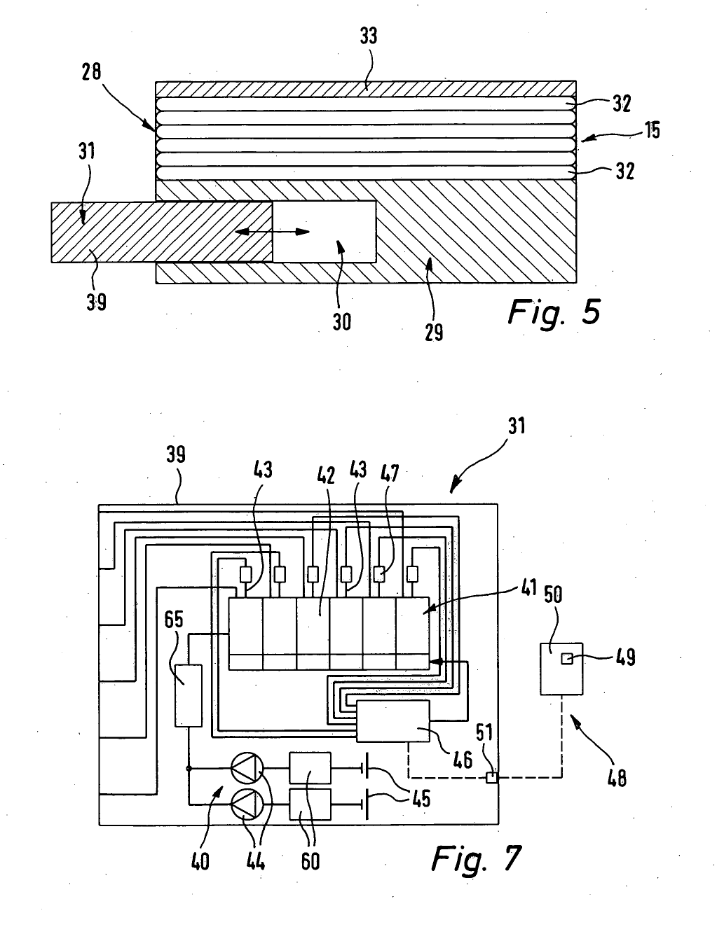

A fluidic lifting device 16 is provided that comprises lifting means in the form of several fluidic actuators that can be filled with compressed fluid independently of one another and are realized in the form of lifting cushions 32 that can be expanded by means of fluid pressure. The lifting cushions 32 serve for raising the lifting bottom 33 that, in turn, carries the goods 23 to be presented. Compressed air is used as the compressed fluid. FIG. 5, in particular, shows that the lifting cushions 32 are folded on top of one another on the intermediate bottom 27 when they are not in use, and that the lifting bottom 33 essentially ends flush with the upper edge of the frame 17 (FIG. 3). This results in a compact base part 15 that can be easily handled. Approximately square depressions 34 are arranged on the upper side of the lifting bottom 33 and serve for accommodating the legs of another carrier pallet 12. This ensures an adequate stackability of such modules consisting of a base part 15 and a carrier pallet 12.

FIG. 2 shows an example of the operative position of the lifting cushions 32, in which all lifting cushions 32 are expanded by means of compressed air. It was already mentioned above that the lifting cushions 32 can be filled with compressed air independently of one another such that the lifting cushions 32 can be inflated one by one depending on the height of the goods in order to raise the lifting bottom 33.

The lifting cushions 32 respectively feature an expansion limiting device for limiting the lifting cushion expansion, namely in the form of a tension thread arrangement 35 with several tension threads 36 that is integrated into the respective lifting cushion 32. The lifting cushion expansion is limited in such a way that the upper side and the lower side of the lifting cushion form supporting surfaces 37 that are aligned parallel to one another in the operative position. This prevents the lifting bottom 33 from assuming an inclined position during the inflation of at least one lifting cushion 32 that could cause the goods 23 lying thereon to shift. FIG. 2, in particular, shows that a separate compressed air hose 38 is assigned to each lifting cushion in order to fill the lifting cushions 32 independently of one another, wherein one end of said compressed air hose leads into the respective lifting cushion 32 via a compressed air fitting and the other end is connected to (not-shown) pneumatic fittings or compressed air outlets on the plug-in module 31.

As mentioned above, the plug-in module 31 can be inserted into the receptacle shaft 30 on the base part, i.e., above the legs 14 of the carrier pallet 12, and exchanged when necessary. The plug-in module 31 features a module housing 31, in which the components of a control device 40 for controlling the lifting device 16 are arranged. FIG. 7, in particular, shows that the control device 40 features a valve mechanism 41 with a number of valves 42 that corresponds to the number of lifting cushions 32. The valves 42 may be realized in the form of piezo-valves. Working connections 43 situated at the outlets of the valves 42 are connected to the compressed air outlets provided on the module housing 39 via fluid lines such as, for example, hoses.

The compressed air fed to the valve mechanism 41 originates at a compressed air generator in the form of at least one compressor 44 that is situated aboard the plug-in module 31. According to the preferred embodiment, two compressors 44 are provided. The compressors 44 are respectively driven electrically, particularly by means of an electric motor 60. The compressors 44 do not directly act upon the valve mechanism 41, but rather feed a pressure accumulator 65 that, in turn, releases compressed air to the valve mechanism 41. Furthermore, a power supply unit is provided that features at least one mains-independent power supply in the form of an accumulator 45 that is situated aboard the plug-in module 31. Although this makes the plug-in module 31 self-sufficient with respect to power engineering, it would also be possible to provide an additional connection to the power supply system. According to the preferred embodiment, two accumulators are provided.

Furthermore, a control unit 46 provided for controlling the valve mechanism 41 is also situated aboard the plug-in module 31. Control commands are transmitted from the control unit 46 to the valves 42 of the valve mechanism 41 such that a switching process of the controlled valve or the controlled valves 42 takes place. The control unit 46 is furthermore coupled to pressure sensors 47 that are arranged in the region of the working connections or directly on the working connections 43 of the valves 42. This makes it possible to determine the instantaneous actual air pressure in the respective lifting cushions 32. This actual air pressure is then transmitted to the control unit 46, in which an actual-nominal value comparison with a stored maximum air pressure and, if applicable, a stored minimum air pressure is carried out. If the maximum air pressure has been reached, the inflation of the lifting cushion 32 in question can be stopped by switching the corresponding valve 42. It is furthermore possible to initiate an inflation process if the air pressure falls short of the minimum air pressure.

In addition, an activation device is provided for activating the lifting device 16 and is coupled to the control unit 46. The activation device 48 features an activation switch 49 that is arranged on an external activation module 50, wherein the signal transmission to the control unit 46 takes place in a wireless fashion, particularly via radio. This means that the activation is realized via remote-control. The activation module 50 preferably makes it possible to activate the lifting devices of several goods presentation arrangements 11. The activation device 48 also features a selector switch 51 that is preferably arranged directly on the plug-in module 31. The selector switch 51 can be switched over with the hand or with the foot between an on-position that allows the activation by means of the activation switch 49 and an off-position that blocks the activation. Consequently, the goods presentation arrangement 11 initially needs to be cleared or “armed” by means of the selector switch 51 before the lifting device 16 can be activated.

The rear side of the plug-in module 31 contains (not-shown) centering bores, into which centering pins arranged in the receptacle shaft 30 can engage in order to center the plug-in module 31 in the receptacle shaft 30. Furthermore, a lock-like locking element 55 is provided for locking the plug-in module 31 in the receptacle shaft 30. The rear side of the plug-in module 31 may also be provided with a (not-shown) contact switch that detects the correct insertion of the plug-in module 31.

The goods presentation arrangement 11 usually is already completely loaded with goods 23 when it is delivered. In this case, the goods 23 are stacked on top of one another in several rows that are laterally fixed by means of the side walls 22. The lifting cushions 32 are initially still in their non-operative position, in which they are folded in the base part 15. If several stacked layers of goods 23 are depleted, the buyer would have to reach more or less far into the container opening defined by the side walls 22 in order to still obtain goods 23. The lifting device 16 is provided in order to avoid this inconvenience.

In order to activate the lifting device 16, the selector switch 51 is initially switched into its on-position such that the lifting device 16 can be activated. The activation is realized by actuating the activation switch 49 that transmits an activation signal to the control unit 46 via radio. The control unit 46, in turn, transmits a control signal to the valve mechanism in order to initiate a switching process such that the respective bottom or top lifting cushion 32 is inflated. This raises the lifting bottom 33 and consequently the goods 23 stacked thereon.

The tension thread arrangement 35 with the tension threads 36 ensures that the upper side and the lower side form supporting surfaces 37 that lie parallel to one another during the inflation such that the lifting bottom 33 remains in its horizontal position, i.e., it does not assume an inclined position that could cause the goods 23 to shift. The inflation of the lifting cushion 32 is continued until the maximum air pressure is reached. This can be determined with the pressure sensor 47 that is arranged on the assigned valve 42 and measures the actual air pressure in the lifting cushion 32, wherein this pressure sensor transmits sensor signals to the control unit 46, in which an actual-nominal value comparison of the air pressure is carried out. The control unit 46 in turn generates a control command that leads in turn to a switching process of the valve 42 in question, whereby the compressed air supply is interrupted in this case. If the lifting bottom 33 should be additionally raised, the lifting device 16 is activated one more time. Information indicating that one lifting cushion 32 is already inflated is now stored in the control unit 46. This causes the control unit 46 to send a control command to the valve 42 assigned to the lifting cushion 32 that is situated adjacent to the already inflated lifting cushion 32. This adjacent lifting cushion 32 is then inflated. The inflation of additional lifting cushions 32 makes it possible to raise the lifting bottom 33 even farther.

Once the last stacked layer of goods 23 is depleted, the lifting cushions 32 can be deflated again such that the lifting bottom 33 is once again lowered into the position shown in FIG. 3, in which it essentially ends flush with the upper frame edge of the frame 17. The side walls of cardboard material can be pulled out of the receptacle opening 41 by disengaging the snap-in device and subsequently disposed. The module consisting of the carrier pallet 12 and the base part 15 can be sent back to the supplier in order to be restocked with goods 23 or the module could be stocked with new and, if applicable, other goods 23 on-site. If the plug-in module 31 is damaged or malfunctions, it can be easily pulled out of the receptacle shaft 30 and replaced with a new plug-in module, if so required. It is furthermore possible to interchange the base parts 15 if the lifting device 16 is damaged or malfunctions. All in all, the greatest flexibility possible is achieved with the inventive goods presentation arrangement 11. The modular design allows an adaptation to different environments. The storage surface areas and footprints are optimally utilized.

What is claimed is:

1. A goods presentation arrangement with a base part that can be placed on the ground by means of legs and comprises a lifting device with a lifting bottom that can be raised with the aid of lifting means and carries the goods, as well as a control device that is assigned to the lifting device and serves for controlling the lifting means, wherein the control device forms part of an exchangeable plug-in module that can be inserted into a receptacle shaft on the base part and is arranged above the legs.

2. The goods presentation arrangement according to claim 1, wherein the legs form part of a carrier pallet that is realized separately from the base part and carries the base part.

3. The goods presentation arrangement according to claim 1, further comprising a fluidic lifting device with lifting means in the form of several fluidic actuators that can be filled with compressed fluid independently of one another.

4. The goods presentation arrangement according to claim 3, wherein the fluidic actuators are formed by lifting cushions that can be expanded by means of fluid pressure.

5. The goods presentation arrangement according to claim 4, wherein an expansion limiting device for limiting the lifting cushion expansion is respectively assigned to the lifting cushions such that the upper side and the lower side of the lifting cushion form supporting surfaces that are aligned parallel to one another in the expanded operative state of the respective lifting cushion.

6. The goods presentation arrangement according to claim 5, wherein the expansion limiting device is formed by a tension thread arrangement with several tension threads that is integrated into the respective lifting cushion.

7. The goods presentation arrangement according to claim 1, wherein the plug-in module comprises a module housing in which components of the control device are accommodated.

8. The goods presentation arrangement according to claim 1, wherein the control device comprises:
a valve mechanism for controlling the lifting means;
a control unit for controlling the valve mechanism;
a fluid supply device arranged upstream of the valve mechanism;
a power supply unit; and
an activation device that is coupled to the control unit and serves for activating the lifting device.

9. The goods presentation arrangement according to claim 8, wherein the control device comprises pressure sensors that are arranged at the outlet of the valve mechanism and are coupled to the control unit in order to monitor the actual fluid pressure in the fluidic actuators.

10. The goods presentation arrangement according to claim 2, further comprising a fluidic lifting device with lifting means in the form of several fluidic actuators that can be filled with compressed fluid independently of one another.

11. The goods presentation arrangement according to claim 10, wherein the fluidic actuators are formed by lifting cushions that can be expanded by means of fluid pressure.

12. The goods presentation arrangement according to claim 11, wherein an expansion limiting device for limiting the lifting cushion expansion is respectively assigned to the lifting cushions such that the upper side and the lower side of the lifting cushion form supporting surfaces that are aligned parallel to one another in the expanded operative state of the respective lifting cushion.

13. The goods presentation arrangement according to claim 12, wherein the expansion limiting device is formed by a tension thread arrangement with several tension threads that is integrated into the respective lifting cushion.

14. The goods presentation arrangement according to claim 2, wherein the plug-in module comprises a module housing in which components of the control device are accommodated.

15. The goods presentation arrangement according to claim 2, wherein the control device comprises:
a valve mechanism for controlling the lifting means;
a control unit for controlling the valve mechanism;
a fluid supply device arranged upstream of the valve mechanism;
a power supply unit; and
an activation device that is coupled to the control unit and serves for activating the lifting device.

16. The goods presentation arrangement according to claim 15, wherein the control device features pressure sensors that are arranged at the outlet of the valve mechanism and are coupled to the control unit in order to monitor the actual fluid pressure in the fluidic actuators.

17. The goods presentation arrangement according to claim 3, wherein the plug-in module comprises a module housing in which components of the control device are accommodated.

18. The goods presentation arrangement according to claim 3, wherein the control device comprises:
a valve mechanism for controlling the lifting means;
a control unit for controlling the valve mechanism;
a fluid supply device arranged upstream of the valve mechanism;
a power supply unit; and
an activation device that is coupled to the control unit and serves for activating the lifting device.

19. The goods presentation arrangement according to claim 18, wherein the control device comprises pressure sensors that are arranged at the outlet of the valve mechanism and are coupled to the control unit in order to monitor the actual fluid pressure in the fluidic actuators.
